(19) United States
(12) Patent Application Publication
(10) Pub. No.: US 2004/0102300 A1
(43) Pub. Date: May 27, 2004

(54) Process for producing sealed container and blank for sealed container

(75) Inventors: Yoji Nishio, Tokushima (JP); Masakatsu Kondo, Tokushima (JP); Yasuji Fujikawa, Tokushima (JP); Michio Ueda, Tokushima (JP)

Correspondence Address: ARMSTRONG, KRATZ, QUINTOS, HANSON & BROOKS, LLP, 1725 K STREET, NW, SUITE 1000, WASHINGTON, DC, 20006, US

(73) Assignee: SHIKOKU KAKOKI CO., LTD., Tokushima (JP)

(21) Appl. No.: 10/718,582

(22) Filed: Nov. 24, 2003

Related U.S. Application Data
(62) Division of application No. 10/058,944, filed on Jan. 30, 2002.

(30) Foreign Application Priority Data
Feb. 5, 2001 (JP) PAT.2001-27663

(51) Int. Cl. B31B 1/90

(52) U.S. Cl. 493/218

(57) ABSTRACT

A process for producing a sealed container from a tubular blank of square cross section by folding and sealing a container bottom forming portion of the blank to form a flat bottom includes the step of sealing the bottom by collapsing an opening edge part of the container bottom forming portion to a flat form and sealing opposed walls of the collapsed opening edge part as lapped over each other to form a straight bottom seal rib.

### CROSS REFERENCE TO RELATED APPLICATION

This application is a division of Ser. No. 10/058,944, filed Jan. 30, 2002.

### BACKGROUND OF THE INVENTION

The present invention relates to a process for producing sealed containers filled, for example, with a beverage such as milk and container blanks for use in practicing the process.

Already known is a process for producing a sealed container from a tubular blank of square cross section by folding and sealing a container bottom forming portion of the blank to form a flat bottom. With this conventional process, the tubular blank is fitted around a mandrel with its bottom forming portion projecting from the mandrel, the bottom forming portion is heated with a heater in advance, one of two pairs of opposed bottom panels of the bottom forming portion are thereafter folded in two between the other pair of bottom panels, the other pair of the folded bottom panels are lapped over the folded bottom panels to form the entire bottom forming portion generally flat, and a pressure member is pressed against the outer end of the mandrel with the flat bottom forming portion interposed therebetween to heat-seal the flat lap of the two pairs of bottom panels.

The mandrel is essential in practicing the conventional process described above. A plurality of mandrels are mounted as arranged radially on a horizontal rotary shaft to provide a rotor. A group of devices including the heater are arranged around the rotor. A considerably great space is required for the installation of the rotor and the group of devices. For this reason, the packaging machine for making blanks into sealed containers which are filled with contents as final products inevitably becomes complex in overall construction and greater in scale.

### SUMMARY OF THE INVENTION

An object of the present invention is to provide a process for producing a sealed container from a tubular blank of square cross section by folding and sealing a container bottom forming portion of the blank to form a flat bottom without using a mandrel, and to provide the container blank for use in practicing the process, the process further serving to provide a packaging machine which is simplified in overall construction.

The present invention provides a process for producing a sealed container from a tubular blank of square cross section by folding and sealing a container bottom forming portion of the blank to form a flat bottom, the process being characterized in that the process includes the step of sealing the bottom by collapsing an opening edge part of the container bottom forming portion to a flat form and sealing opposed walls of the collapsed opening edge part as lapped over each other to form a straight bottom seal rib.

To seal the bottom forming portion, the opening edge part which extends straight like a strip and is formed by collapsing the bottom forming portion to a flat form needs only to be clamped from opposite sides thereof in the case of the process of the invention. Accordingly, there is no need to place a mandrel or the like into the blank. The striplike opening edge part can be sealed, for example, by ultrasonic sealing. Thus, the use of the process of the invention serves to simplify the overall construction of the packaging machine.

The process of the invention further includes the step of sealing a top by forming a container top forming portion of the blank into a top in the form of a gabled roof and forming at a top portion corresponding to the ridge of the roof a top seal rib having inwardly folded gussets, the bottom sealing step and the top sealing step being so practiced that the bottom seal rib and the top seal rib are positioned across each other when seen axially of the blank. When the blank is formed while being transported on a conveyor, the bottom seal rib is so formed as to extend, orthogonal to the direction of travel of the conveyor. Interference between the bottom seal ribs of adjacent blanks can then be avoidable with ease. When the top seal rib is so formed as to extend in parallel to the direction of travel of the conveyor, the top seal rib becomes easy to form from opposite sides of the blank. The pitch of blanks to be transported can then be diminished.

Preferably, the bottom sealing step is followed by the step of sealing ears by forming the entire container bottom forming portion to a flat form so as to cause a pair of triangular ears to project from a lower end of a container trunk forming portion longitudinally of the bottom seal rib and joining the triangular ears as lapped over the flat part of the container bottom forming portion by sealing.

In practicing the process described above, it is most suitable to use a sealed container tubular blank which has a blank body in the form of a generally rectangular plate, the blank body having generally rectangular first to fourth panels extending continuously along the periphery of the blank with first to third vertical scores provided between the adjacent panels, the first to fourth panels respectively comprising first to fourth top panels, first to fourth trunk panels integral with the first to fourth top panels with first to fourth top horizontal scores formed therebetween, and first to fourth bottom panels integral with the first to fourth trunk panels with first to fourth bottom horizontal scores formed therebetween, odd-numbered or even-numbered two top panels among the first to fourth top panels being each provided with an inverted V-shaped roof folding score, odd-numbered or even-numbered two bottom panels among the first to fourth bottom panels being each provided with a V-shaped ear folding score.

When this blank is used, the bottom seal rib and the top seal rib can be so formed as to be positioned across each other when seen axially of the blank.

When the two bottom panels having no ear folding score each have an outer end projecting beyond outer ends of the two bottom panels each provided with the ear folding score axially of the blank, the finger of a picker used for unfolding the blank as folded flat into a tube of square cross section can be engaged with the projecting portion of the bottom panel, whereby the blank can be opened by a stabilized movement.

The two bottom horizontal scores formed between the two bottom panels each provided with the ear folding score and the two trunk panels adjacent thereto are shifted from the other two bottom horizontal scores toward the trunk panel, and are different from the latter scores in level. The portion of the blank to be folded flat is then positioned toward the trunk panel side, enabling the container as completed to be seated or positioned upright with good stability.

The two bottom horizontal scores formed between the two bottom panels each provided with the ear folding score and the two trunk panels adjacent thereto are V-shaped as bulged toward the trunk panel. The portion of the blank to be folded flat can then be positioned toward the trunk panel side more effectively, rendering the container positionable upright with improved stability.

The blank body has a striplike fifth panel integral with the fourth panel, with a fourth vertical score formed therebetween, and joined to an inner surface of a free edge portion of the first panel by sealing, the two top panels each provided with the roof folding score are the first and third top panels, and the two bottom panels each provided with the ear folding score are the second and fourth bottom panels. When the top forming portion is folded into a gabled roof, the fifth panel is so bent with the first top panel as to extend obliquely, whereas the first bottom panel remains flat and is not folded when the bottom forming portion is folded flat. Accordingly, the fifth panel is not folded. This diminishes the damage to the fifth panel when the bottom forming portion is folded.

If the first bottom panel is provided with an ear folding score, the first bottom panel is folded in two to form a triangular ear when the bottom forming portion is folded, with the result that the fifth panel is also folded with the first bottom panel. Since the bottom forming portion is folded with greater severity than the top forming portion, the fifth panel to be folded along with the first bottom panel will then be damaged to a greater extent.

### BRIEF DESCRIPTION OF THE DRAWINGS

FIG. 1 is a perspective view of a container produced by the process of the invention;

FIG. 2 is a view in development of a blank for the container;

FIG. 3 includes enlarged fragmentary views in section of the blank;

FIG. 4 is a perspective view of the blank in a flat form before being opened;

FIG. 5 is a perspective view of the blank as opened in the form of a tube of square cross section;

FIG. 6 is a perspective view of the blank as closed at a bottom forming portion thereof;

FIG. 7 is a perspective view of the blank as closed at a top forming portion thereof;

FIG. 8 is a perspective view of the blank with its bottom forming portion made flat;

FIG. 9 is a perspective view of the container with the bottom forming portion formed to a final shape;

FIG. 10 is a view in section taken along the line X-X in FIG. 1;

FIG. 11 is a view in section taken along the line XI-XI in FIG. 1; and

FIG. 12 is a view in section taken along the line XII-XII in FIG. 1.

### DESCRIPTION OF THE PREFERRED EMBODIMENT

An embodiment of the present invention will be described below with reference to the drawings.

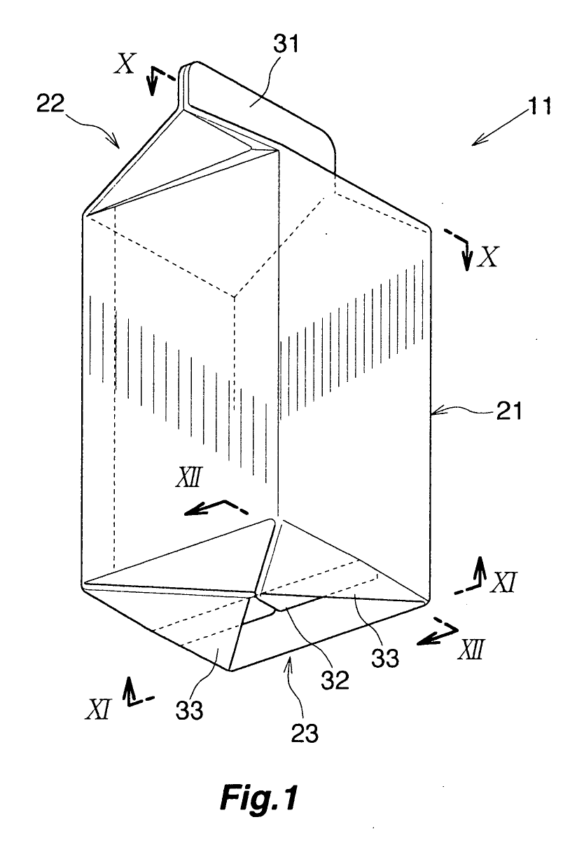

FIG. 1 shows a container 11 produced by the process of the present invention. The container 11 comprises a tubular trunk 21 of square cross section, a top 22 in the form of a gabled roof and integral with the upper end of the trunk 21, and a bottom 23 formed flat and integral with the lower end of the trunk 21.

An upwardly projecting top seal rib 31 is formed at the portion of the top 22 corresponding to the ridge of the roof. The bottom 23 has a bottom seal rib 32 and a pair of triangular ears 33. The bottom seal rib 32 extends from the outer end of one of the ears 33 to the outer end of the other ear 33 over the flat bottom wall of the bottom 23. The midportion of the rib 32 is positioned on the flat bottom wall of the bottom 23, and opposite side portions of the rib 32 are folded over and secured to the rib midportion in a lapping manner. The top seal rib 31 and the bottom seal rib 32 are positioned across each other when seen from above.

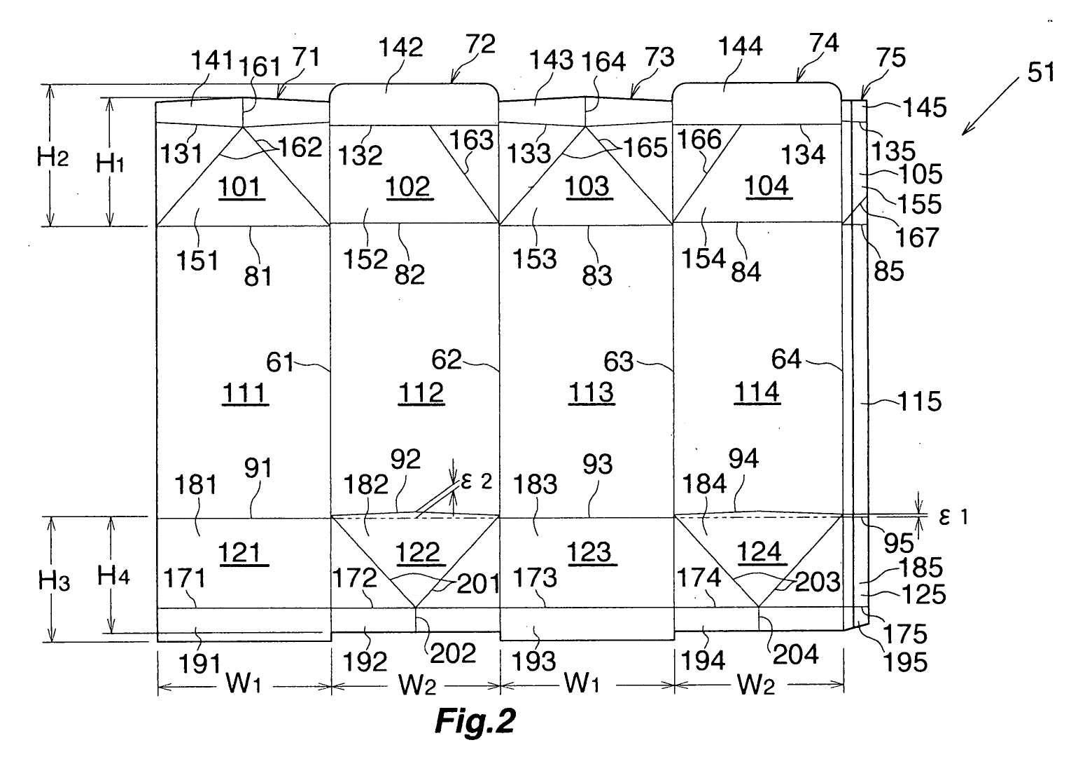

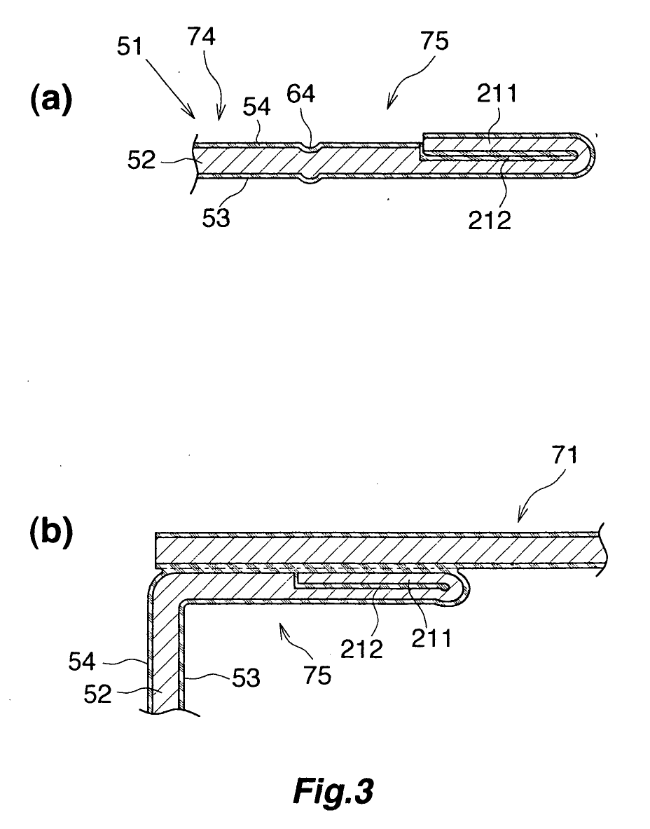

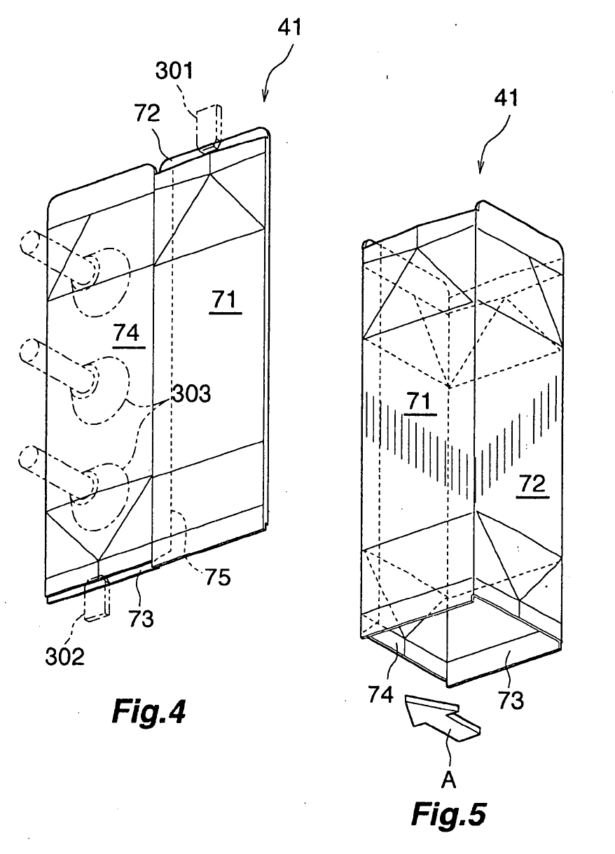

The container 11 is produced from a tubular blank 41 folded to a flat form (see FIG. 4). The blank 41 comprises a horizontally elongated, generally rectangular blank body 51 shown in FIG. 2. The blank body 51 is shown in FIG. 2 as it is seen from the outer side of the container to be formed. The blank body 51 is in the form of a flat sheet comprising a paper layer 52 and polyethylene layers 53, 54 respectively covering inner and outer surfaces of the paper layer (see FIG. 3).

The blank body 51 has first to third scores 61 to 63 extending vertically and arranged from the left edge thereof toward its right edge at a spacing to divide the width of the body into four approximately equal portions, and a fourth vertical score 64 close to the right edge of the body 51. These first to fourth vertical scores 61 to 64 divide the blank body 51 into first to fourth panels 71 to 74 each in the form of a vertically elongated rectangle and a striplike fifth panel 75 which are integral with one another as arranged from the left rightward.

The blank body 51 is provided at an upper portion thereof with first to fifth top horizontal scores 81 to 85 formed in the respective first to fifth panels 71 to 75 and generally aligned horizontally, and at a lower portion thereof with first to fifth bottom horizontal scores 91 to 95 similarly formed in the panels 71 to 75 and generally aligned horizontally. These first to firth top scores 81 to 85 and first to fifth bottom scores 91 to 95 respectively divide the first to fifth panels 71 to 75 into first to fifth top panels 101 to 105, first to fifth trunk panels 111 to 115 and first to fifth bottom panels 121 to 125 which are respectively integral with one another as arranged from above downward.

The first to fifth top panels 101 to 105 provide a top forming portion, the first to firth trunk panels 111 to 115 provide a trunk forming portion, and the first to fifth bottom panels 121 to 125 provide a bottom forming portion.

First to fifth top wall rib scores 131 to 135 are formed in the respective first to fifth top panels 101 to 105 along their upper edges. These rib scores 131 to 135 divide the top panels 101 to 105 into first to fifth top wall rib panels 141 to 145 and first to fifth top wall panels 151 to 155 which are respectively integral with each other vertically.

A vertical first top wall rib middle score 161 is formed in the middle of the first top wall rib panel 141. An inverted V-shaped first roof folding score 162 is formed in the first top wall panel 151 for connecting the lower end of the middle score 161 to opposite ends of the first top horizontal score 81. A first oblique score 163 is formed in the second top wall panel 152 for connecting a portion of the second top wall rib score 132 slightly rightward from the midportion thereof to the right end of the second top horizontal score 82. Like the rib panel 141, the third top wall rib panel 143 has a vertical second top wall rib middle score 164 at its midportion. Like the first top wall panel 151, the third top wall panel 153 has an inverted V-shaped second roof folding score 165 for connecting the lower end of the middle score 164 to opposite ends of the third top horizontal score 83. A second oblique score 166 slanting in the opposite direction to the first oblique score 163 is formed in the fourth top wall panel 154 for connecting a portion of the fourth top wall rib score 134 slightly leftward from the midportion thereof to the left end of the fourth top horizontal score 84. An oblique folding score 167 is formed in the fifth top wall panel 155 close to its lower end. This score 167 is shaped in match with the lower end portion of left slanting portion of the first roof folding score 162.

First to fifth bottom wall rib scores 171 to 175 are formed in the respective first to fifth bottom panels 121 to 125 along their lower edges. These rib scores 171 to 175 divide the bottom panels 121 to 125 into first to fifth bottom wall panels 181 to 185 and first to fifth bottom wall rib panels 191 to 195 which are respectively integral with each other vertically.

The second bottom wall panel 182 has a V-shaped first ear folding score 201 for connecting opposite ends of the second bottom horizontal score 92 to the midportion of the second bottom wall rib score 172. The second bottom wall rib panel 192 is provided at its midportion with a vertical first bottom wall rib middle score 202 extending downward from the lower end of the score 201. Like the second bottom wall panel 182, the fourth bottom wall panel 184 has a V-shaped second ear folding score 203 for connecting opposite ends of the fourth bottom horizontal score 94 to the midportion of the fourth bottom wall rib score 174. Like the second bottom wall rib panel 192, the fourth bottom wall rib panel 194 is provided at its midportion with a vertical second bottom wall rib middle score 204 extending downward from the lower end of the score 203.

Thus the blank body is divided into various panel groups by the scores.

On the other hand, the fifth panel 75 is skived over the approximate half of width thereof toward its outer end. As shown in detail in FIG. 3(a), the skived portion has a portion 211 of reduced thickness by removing the approximate half of thickness of the blank body 51 from its outer surface side, and the outer end part of the reduced thickness portion 211 is folded over outward at the middle of width of this portion to provide a lapped part. Since the polyethylene layer 54 providing the outer surface is also removed when the reduced thickness portion 211 is formed, a new polyethylene layer 212 is formed on the outer surface of the portion 211 to supplement the removed polyethylene layer 54.

Next, the shape of the blank body 51 will be described below in detail although the drawings may not show the shape apparently.

The first panel 71 and the third panel 73 have the same width W1, and the second panel 72 and the fourth panel 74 also have the same width W2. However, the latter width W2 is smaller than the former width W1, for example, by about 0.5 to about 2.0 mm.

The first top panel 101 and the third top panel 103 have the same height H1, and the second top panel 102 and the fourth top panel 104 also have the same height H2, whereas the latter height H2 is greater than the former height H1. The upper edges of the second top panel 102 and the fourth top panel 104 project upward beyond the upper edges of the first top panel 101 and the third top panel 103 by an amount equal to the difference between the heights H2 and H1. The amount of projection is, for example, 3 mm.

The shape of the first to fifth top panels 101 to 105 and the shape of the first to fifth trunk panels 111 to 115 are well known and will not be described further in detail. The first to fifth bottom panels 121 to 125 only will be described below.

The first bottom panel 121 and the third bottom panel 123 have the same height H3, and the second bottom panel 122 and the fourth bottom panel 124 also have the same height H2, whereas the former height H3 is greater than the latter height H4. The lower edges of the first bottom panel 121 and the third bottom panel 123 project downward beyond the lower edges of the second bottom panel 122 and the fourth bottom panel 124 by an amount equal to the difference between the heights H3 and H4. The amount of projection is, for example, 3 mm.

Thus, the first bottom panel 121 and the third bottom panel 123 both have a projection, whereas the third bottom panel 123 only may have the projection. In the case where the four bottom panels 121 to 124 have their lower edges aligned without causing the first bottom panel 121 and the third bottom panel 123 to project, a cutout in place of the projection may be formed in at least one of the second and fourth bottom panels 122, 124.

The second and fourth bottom horizontal scores 92, 94 are shifted upward from the first, third and fifth bottom horizontal scores 91, 93, 95, and each pair of adjacent scores among these five scores 91 to 95 are different in level. The amount of step 1 is, for example, 1 mm. Furthermore, although the first, third and fifth bottom horizontal scores 91, 93, 95 extend straight, the second and fourth bottom horizontal scores 92, 94 extend as upwardly bulged in a V-shape. The maximum amount of bulge 2 at the midportion of the arch is, for example, 1 mm.

The first panel 71 and the second panel 72 of the blank body 51 are folded in two along the first vertical score 61, the third panel 73 and the fourth panel 74 are folded in two along the third vertical score 63, and the outer surface of the fifth panel 75 is joined to the inner surface of free edge portion of the first panel 71 by sealing [see FIG. 3(b)], whereby a tubular blank 41 is obtained which is folded flat. At this time, the oblique folding score 167 is aligned with the lower end portion of the left slanting line of the first roof folding score 162.

The flat blank 41 is made into a container 11 as finally shaped and filled with contents in the manner to be described below stepwise.

Blanks 41 are accommodated in a magazine (not shown), as arranged in a vertical position as seen in FIG. 4. In this state, the first and fourth panels 71, 74 of the blank 41 face toward a delivery opening of the magazine (toward the front side of the plane of FIG. 4). Blanks 41 are taken out of the magazine one by one by a picker. The upper edge and the lower edge defining the delivery opening are provided with an upper finger 301 and lower finger 302 of the picker. The picker has suction members 303 which come into contact with the fourth panel 74 under suction, pulling the panel toward the front side of the plane of the drawing. This brings the upper finger 301 into engagement with the upper edge portion of the second panel 72, and the lower finger 302 into engagement with the lower edge portion of the third panel 73. At this time, the upper edge of the second panel 72 is positioned as slightly projected upward beyond the upper edge of the first panel 71, and the lower edge of the third panel 73 is positioned as slightly projected downward beyond the lower edge of the fourth panel 74, so that the upper and lower fingers 301, 302 are advantageously engaged with the projecting ends of the second and third panels 72, 73. The fourth panel 74 is pulled in this state toward the front side of plane of the drawing, whereby the flat blank 41 is taken out of the delivery opening while being opened into a tube of square cross section.

The blank 41 delivered is held by a holder on a conveyor (not shown) while being retained in the tubular form. FIG. 5 shows the direction of transport by the conveyor as indicated by an arrow A. At this time, the first panel 71 faces toward the downstream side of the direction of transport. Accordingly, the second and fourth panels 72, 74 face toward directions orthogonal to the direction of transport.

While blanks 41 are transported on the conveyor, the required packaging operation to be described below is performed.

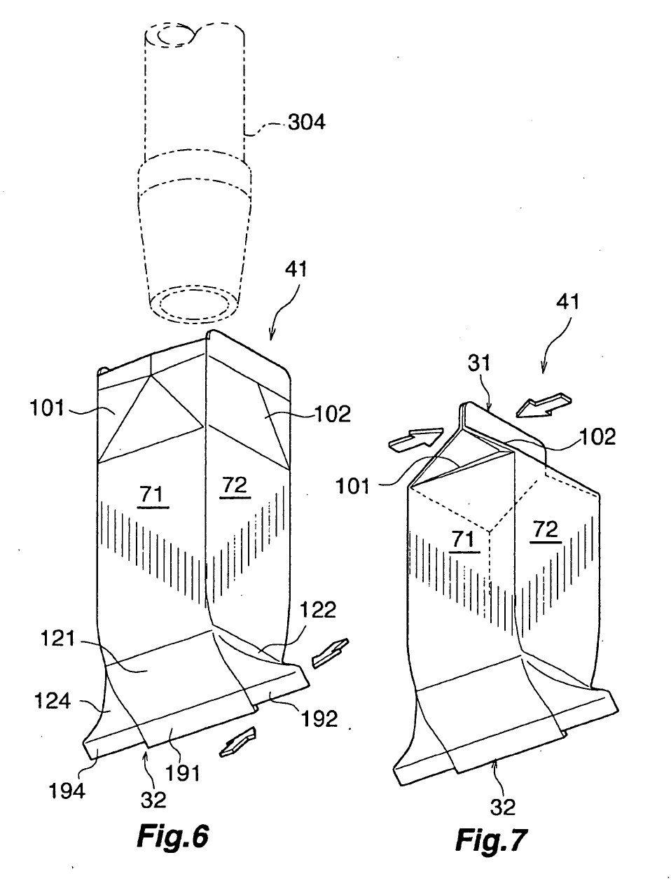

First as shown in FIG. 6, a bottom sealing step is performed by collapsing the opening edge part of the container bottom forming portion to a flat form and sealing the opposed walls of the opening edge part as lapped over each other to form a straight bottom seal rib 32.

First, the outer ends of the second and fourth bottom panels 122, 124 are pushed open away from each other. This movement collapses the outer ends of the first and third bottom panels 121, 123 so as to conversely bring these ends toward each other, thereby folding the second and fourth bottom wall rib panels 192, 194 in two and lapping the first and third bottom wall rib panels 191, 193 over each other generally into a straight strip. The lapped rib panels 191, 193 are caused to fall down upstream with respect to the direction of transport, as inclined at an angle of about 45 degrees with respect to a vertical. In this state, required portions of the first and second bottom wall rib panels 191, 193 are temporarily sealed to prevent the panels 191, 193 from shifting from each other vertically. Subsequently the portions of the second and fourth bottom wall rib panels 192, 194 folded in two and the entire rib panels 191, 193 are fully sealed, whereby the bottom seal rib 32 is formed. Full sealing is done by an ultrasonic sealing device. When to be sealed by this device, the portions to be made into the rib 32 are clamped from opposite sides and exposed to ultrasonic waves, so that there is no need to place a mandrel or the like into the blank 41.

The use of ultrasonic sealing is advantageous for aseptic filling, whereas heat sealing may alternatively be resorted to. Temporary sealing is not always necessary.

When subjected to the bottom sealing step, the bottom forming portion is bulged downward in its entirety.

After the bottom seal rib 32 has been formed, a filling step is performed for filling the blank 41 with contents by a filling nozzle 304.

The filling step is followed by a top sealing step, in which the container top forming portion is formed into a top in the form of a gabled roof, and a top seal rib 31 is formed at a portion corresponding to the ridge of the roof. A known inwardly folded gusset seal is used for the top sealing step. This step will be described below briefly.

The first to fourth top panels 101 to 104 are folded along with the fifth top panel 105 so that the first and third top panels 101, 103 are positioned inside the second and fourth top panels 102, 104. The first and third top wall panels 151, 153 are folded along the first and second roof folding scores 162, 165 so as to bring the upper edge midportions of the panels 151, 153 toward each other, and the first and third top wall rib panels 141, 143 are folded in two and held between the second and fourth top wall rib panels 142, 144, whereby the first to fifth top wall rib panels 141 to 145 are lapped over one another. The resulting lap is heat-sealed to form a top seal rib 31. Instead of heat sealing, ultrasonic sealing may be resorted to for sealing the top.

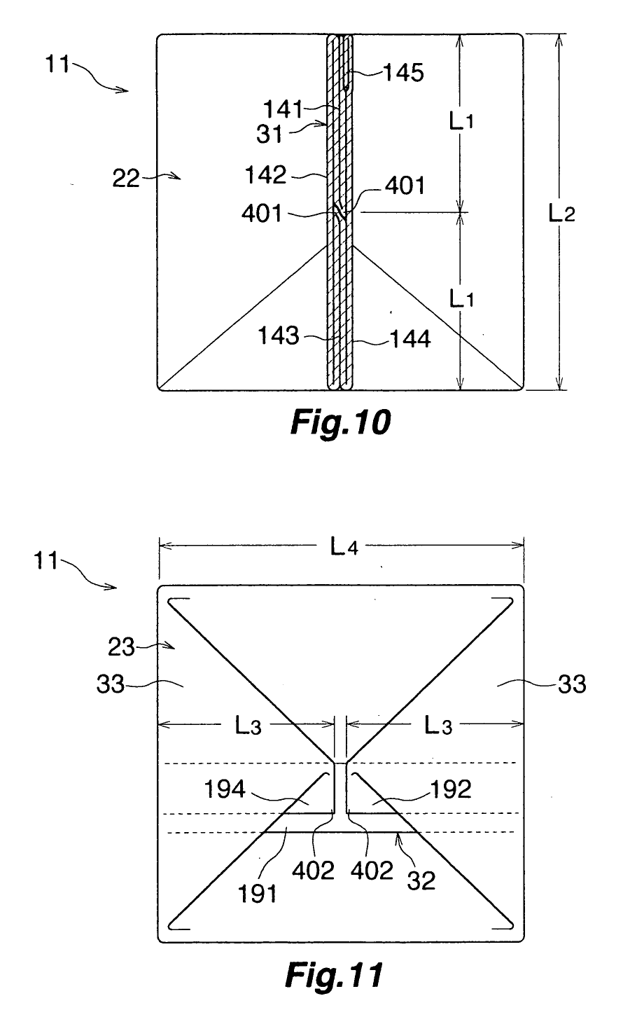

As previously stated, the first and third top wall rib panels 141, 143 are greater than the second and fourth top wall rib panels 142, 144 in length. As shown in FIG. 10, therefore, the combined length L1+L1 of the portions of the first and third top wall rib panels 141, 143 each of which portions is folded in two and has a length L1 is greater than the length L2 of the second and fourth top wall rib panels 142, 144. When the first and third top wall rib panels 141, 143 as folded in two are held between the second and fourth top wall rib panels 142, 144, the bent portions 401 of these panels 141, 143 are butted against each other under great pressure, making it difficult for a clearance to remain between the bent portions 401. This eliminates the leakage of the contents that would otherwise occur through the clearance.

Since the fifth panel 75 is joined to the free edge portion of the first panel 71, the fifth panel 75 is folded along with the first panel 71. When the first top panel 101 is folded along the first roof folding score 162, the fifth panel 75 is folded along the oblique folding score 167 together with the panel 101. The container material is liable to separate off at this bent portion of the fifth panel 75, and this portion is included in the top 22.

The two roof folding scores 162, 165 formed in the first and third top wall panels 101, 103 can be formed alternatively in the second and fourth top wall panels 102, 104, and the two ear folding scores 201, 203 formed in the second and fourth bottom wall panels 122, 124 can be formed alternatively in the first and third bottom wall panels 121, 123. The oblique folding score 167 in the fifth top panel 105 then needs to be formed in the fifth bottom panel 125. This means that the bent portion of the fifth panel 75 in the fifth top panel 105 is positioned alternatively in the fifth bottom panel 125, with the result that the portion susceptible to separation is included in the bottom 23 instead of being included in the top 22. When the top 22 is compared with the bottom 23 in the mode of folding, the top 22 is folded in the form of a roof, while the bottom 23 is folded flat, so that the container material is folded to a more severe extent at the bottom 23. Accordingly, positioning the portion liable to separation at the bottom 23 is disadvantageous.

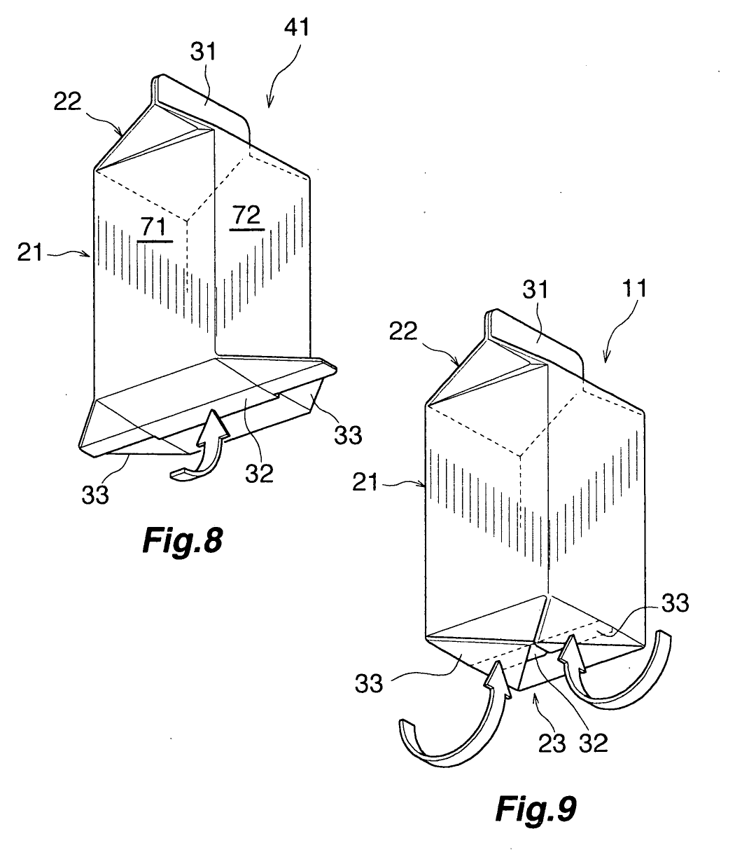

Next, a forming step is performed for forming the container to a final shape. As seen in FIG. 8, the bottom forming portion which is in a downwardly bulging state is formed flat in its entirety. The bottom seal rib 32 is caused to fall down in a direction opposite to the direction of transport by the conveyor, and the second and fourth bottom panels 122, 124 are folded in two so as to lap opposite side portions of each of the first and third ear folding scores 201, 203 over each other, with the scores 201, 203 serving as ridge lines, causing a pair of ears 33 to project outward horizontally. The two ears 33 are then bent downward, further bent inward and lapped over the flat surface of the bottom forming portion. The ears 33 are subjected to a pressure for pressure bonding. Before the ears 33 are bent, the surfaces of the ears 33 to be bonded and the flat surface to which these ears are to be bonded are partly heated with hot air.

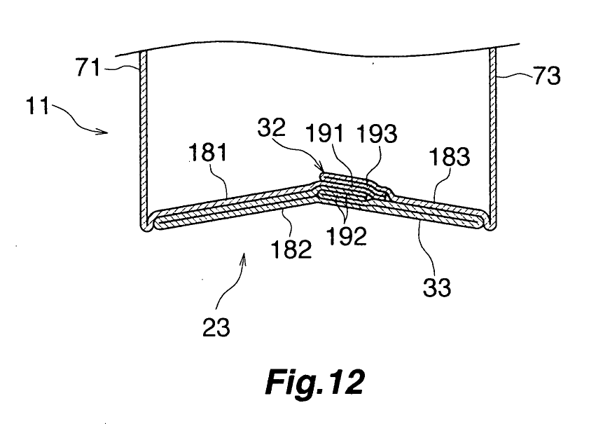

The width W2 of the second and fourth bottom panels 122, 124 is smaller than the width W1 of the first and third bottom panels 121, 123. Further the second and fourth bottom horizontal scores 92, 84 are positioned toward the trunk forming portion beyond the first and third bottom horizontal scores 91, 93 in an upwardly bulging form. As shown in FIG. 12 in detail, therefore, the base portion of the ear 33 is bent so as to be positioned upwardly of the flat bottom forming portion and is made less bulky. As a result, the overall bottom forming portion including the ears 33 is made flatter and becomes easily foldable so as to be recessed in its center as desired.

The second and fourth bottom wall rib panels 192, 194 are folded in two and lapped over the first and third bottom wall rib panels 191, 193. The combined length L3+L3 of the second and fourth bottom wall rib panels 192, 194 each of which is folded in two and has a length L3 is smaller than the length L4 of the first and third bottom wall rib panels 191, 193 as seen in FIG. 11. This is a phenomenon converse to that of the first and third top wall panels 101, 103, meaning that a clearance occurs between the ends 402 of the bottom seal ribs 32 or ears 33 without forming a lap by the end portions. The bottom forming portion can therefore be seated with improved stability.

The top forming portion need not always be folded into a gabled roof but can be so folded as to form a straight striplike seal like the bottom forming portion.

It is desired that the container be sterilized on the conveyor before the bottom forming portion is sealed. Before the bottom forming portion is sealed, the tubular blank is easy to sterilize uniformly in its entirety, whereas uniform sterilization is difficult to realize once a closed bottom is formed.

A spout plug is attached to the container in the following manner. When the plug is to be joined to an edge portion defining an outlet of the container from inside the container, the plug is attached before the blank is supplied to the conveyor, or before the bottom is closed if the plug is attached after the blank is supplied. When the plug is to be attached to the outlet edge portion from outside, the plug is joined simultaneously when or after the ears are joined by sealing.

What is claimed is:

1. A sealed container tubular blank for use in producing a sealed container, the blank having a blank body in the form of a generally rectangular plate, the blank body having generally rectangular first to fourth panels extending continuously along the periphery of the blank with first to third vertical scores provided between the adjacent panels, the first to fourth panels respectively comprising first to fourth top panels, first to fourth trunk panels integral with the first to fourth top panels with first to fourth top horizontal scores formed therebetween, and first to fourth bottom panels integral with the first to fourth trunk panels with first to fourth bottom horizontal scores formed therebetween, odd-numbered or even-numbered two top panels among the first to fourth top panels being each provided with an inverted V-shaped roof folding score, odd-numbered or even-numbered two bottom panels among the first to fourth bottom panels being each provided with a V-shaped ear folding score.

2. A sealed container blank according to claim 1 wherein the two bottom panels having no ear folding score each have an outer end projecting beyond outer ends of the two bottom panels each provided with the ear folding score longitudinally of the blank.

3. A sealed container blank according to claim 1 wherein the two bottom horizontal scores formed between the two bottom panels each provided with the ear folding score and the two trunk panels adjacent thereto are shifted from the other two bottom horizontal scores toward the trunk panel, and are different from the latter scores in level.

4. A sealed container blank according to claim 3 wherein the two bottom horizontal scores formed between the two bottom panels each provided with the ear folding score and the two trunk panels adjacent thereto are V-shaped as bulged toward the trunk panel.

5. A sealed container blank according to claim 4 wherein the blank body has a striplike fifth panel integral with the fourth panel, with a fourth vertical score formed therebetween, and joined to an inner surface of a free edge portion of the first panel by sealing, the two top panels each provided with the roof folding score are the first and third top panels, and the two bottom panels each provided with the ear folding score are the second and fourth bottom panels.

6. A sealed container blank according to claim 1 wherein the blank body has a striplike fifth panel integral with the fourth panel, with a fourth vertical score formed therebetween, and joined to an inner surface of a free edge portion of the first panel by sealing, the two top panels each provided with the roof folding score are the first and third top panels, and the two bottom panels each provided with the ear folding score are the second and fourth bottom panels.

7. A sealed container blank according to claim 2 wherein the blank body has a striplike fifth panel integral with the fourth panel, with a fourth vertical score formed therebetween, and joined to an inner surface of a free edge portion of the first panel by sealing, the two top panels each provided with the roof folding score are the first and third top panels, and the two bottom panels each provided with the ear folding score are the second and fourth bottom panels.

8. A sealed container blank according to claim 3 wherein the blank body has a striplike fifth panel integral with the fourth panel, with a fourth vertical score formed therebetween, and joined to an inner surface of a free edge portion of the first panel by sealing, the two top panels each provided with the roof folding score are the first and third top panels, and the two bottom panels each provided with the ear folding score are the second and fourth bottom panels.
